(19) United States
(12) Patent Application Publication
(10) Pub. No.: US 2009/0319559 A1
(43) Pub. Date: Dec. 24, 2009

(54) Method And System of Using Social Networks and Communities to Ensure Data Quality of Configuration Items in a Configuration Management Database

(76) Inventors: Kurt Westerfeld, Ashburn, VA (US); Adam Cusson, Bristow, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/488,381

(22) Filed: Jun. 19, 2009

Related U.S. Application Data
(60) Provisional application No. 61/079,125, filed on Jul. 8, 2008.
(60) Provisional application No. 61/074,074, filed on Jun. 19, 2008.

(51) Int. Cl. G06F 7/00

(52) U.S. Cl. 707/102; 707/104.1; 707/E17.044

(57) ABSTRACT

A method and system are described for distributing the tasks of ensuring the accuracy and currency of data contained in a CMDB to a social network of communities within the organization. Configuration items (CIs) are organized into Communities, and Users are associated with these Communities. Users associated with a Community search or browse for a CI and review the accuracy of a CI attribute, making correction by modification, deletion or addition. If correct information is not known the user tags the CI attribute for later correction. Corrections are reviewed and either approved or reverted back to the original value of the CI attribute. Through iteration of the process the accuracy of the CMDB is improved.

### RELATED APPLICATIONS

This application claims priority from U.S. Provisional Patent Application No. 61/079,125 titled “Method of Using Social Networks and Communities to Ensure Data Quality of Configuration Items in a Configuration Management Database” filed on Jul. 8, 2008, and from U.S. Provisional Patent Application No. 61/074,074 titled “System and Method for Using a Collaborative Network to Maintain a Configuration Management Database” filed on Jun. 19, 2008.

This application is related to U.S. patent application Ser. No. ______ for “Method And System of Using Social Networks and Communities to Create And Maintain Relationships Between Configuration Items in a Configuration Management Database” and U.S. patent application Ser. No. ______ for “Method and System of Using Structured Social Networks and Communities to Create and Maintain Business Service Models”, both filed contemporaneously herewith and incorporated by reference herein.

### BACKGROUND OF THE INVENTION

1. Field of the Invention

The present invention relates to information technology (IT) systems and more specifically, to methods and apparatus for ensuring that accurate and current data exists in a Configuration Management Database (CMDB) by applying social network and community data management principles to its constituent Configuration Items (CIs) and their attributes.

2. Background Description

IT organizations manage large and complex IT environments to provide a plurality of services to their internal and external customers. The large scale of these environments produces a large volume of configuration information that must be tracked in order to manage the IT environment. This configuration data is typically stored as Configuration Items (CIs) and CI attributes as part of a larger Configuration Management Database (CMDB). The information contained in a CMDB is a critical part of managing the IT environment since it allows IT staff to proactively model the impact of planned changes, while also allowing for lower mean time to resolution (MTTR) of unplanned outages.

A typical CMDB is made up of an hierarchical structure of CIs and their attributes with a number of disparate data sources all being combined to populate the CMDB. These data sources can include (but are not limited to) asset management systems, performance monitoring systems, trouble ticketing systems, service desk solutions, and manual user maintained data sources (e.g. spreadsheets). Despite efforts of manual and automated systems to reconcile and combine these varied data sources, a large majority of CMDBs contain incorrect, outdated, or missing data about CIs and CI attributes. Failure in the reconciliation process results in an overall failure of CMDB projects both in the initial deployment as well as in ongoing maintenance of the system.

The end result is that most IT organizations either fail to complete their CMDB projects or cannot sustain them, and as such will never recognize the value that the CMDB can offer to them. Addressing these challenges requires a new approach to organizing and maintaining CMDB projects.

### SUMMARY OF THE INVENTION

In order to overcome the above described problems with implementing CMDB projects, the present invention organizes and distributes the work among those within the organization closest to, and most knowledgeable about, the respective configuration items and associated attribute data.

Social networking applications have in recent years proliferated. Typically, a social network application facilitates construction of a social network of members connected by a common purpose. For example, members interested in developing a network of business contacts may participate in a network designed for that purpose. Very particular purposes may support a social network, such as travelers with layovers as described in U.S. Patent Publication No. 2009/0077061 to Abercrombie et al. A variety of applications have been developed to provide services to enhance the operation of such networks. For example, Internet based merchandisers may use social networking techniques to add value to shopping experiences by sharing product reviews with network friends as described in U.S. Patent Publication No. 2009/0070228 to Ronen.

Social networks may feature methods for determining social distance between members based on attributes provided by the members. These attributes may also be used to target advertising to members as described in U.S. Patent Publication No. 2009/0112701 to Turpin et al. or, in combination with social distance, may be used to present content to a member as described in U.S. Patent Publication No. 2009/0070700 to Johanson. Methodologies have been devised for one member of a social network to upload content, such as a picture, about another member, as described in U.S. Pat. No. 7,117,254 to Lunt et al.

There are also applications which use social network techniques to address problems that do not, in themselves, have anything to do with social networks. For example, U.S. Patent Publication No. 20090070168 to Thompson et al. describes a system for monitoring the use of electrical power by consumers, where information collected by various measuring devices is shared with a social network of experts. However, there are no prior art uses of social network techniques applied to the above described problems with implementing CMDB projects, and in particular with the challenge of insuring data quality of configuration items in a configuration management database.

Accuracy and currency of CI and CI attribute data stored in a CMDB can be achieved only by providing IT staff with a mechanism by which they can group CIs into manageable sets and allow groups of individuals to own responsibility for validating and maintaining them. This invention describes the process by which individuals can be associated with one or more Communities, each of which also contains CIs and their associated CI attributes. Members of the Communities can search for or browse through the CIs and view, update, delete, tag, comment, generate reports on CIs and CI attributes. A CMDB would have an overlapping social network of Communities, CIs, and individual users whose combined effort will result in verifying and maintaining data contained in the CMDB.

Administrators of the system construct Communities which represent groups of individuals and groups of CIs (and their attributes). Each CMDB Community consists of logically related CMDB data—grouped by function, role, class, or geography, or a combination thereof. IT or business users subscribe to CMDB Communities—usually based on their specific business responsibility. The Communities also contain permissions which map individuals to one or more sets of permissions including (but not limited to) read, create, modify, delete, update, tag, mark, and comment.

The method by which CIs can be associated with Communities is dependent on the underlying CMDB implementation and may vary significantly for each deployment. For example, an initial mapping of CIs to Communities could be defined based on grouping classes of CIs into each Community. In a different deployment scenario, administrators may choose to associate CIs with Communities based on a naming convention, or an attribute that defines physical locations. Another potential grouping involves an application or business process-centric approach, where a community is centered around one or more specific applications or business processes.

A computer based environment is provided to individual users where they can view information about any given CI in a Community, including history of changes that have been made to it. In addition, individuals can choose to add any missing CIs or missing CI attributes. Dated CIs or CI attributes can similarly be deleted. Should any incorrect information be discovered, users have the option of either updating the CI or CI attribute, or can tag the information for update by another member of the Community. Updates can either be automatically approved or go through an approval process prior to being committed into the CMDB.

Members of the Community are given methods by which they can view all CIs and CI attributes that have been tagged. Community activity, such as CI creation, update, or removal, are presented to community members as a time-ordered event display intended to draw participants together with the goal of improving data quality. This allows all members of the Community to contribute their expertise towards improving the overall quality of data in the CMDB.

Community oriented workspaces are provided to facilitate the process by which members of that Community can track activities taking place on contained CIs, including highlighting recently updated CIs, CIs requiring updates, CI updates requiring approvals, new CIs added, and CIs deleted. Individuals are also provided with workspaces to facilitate their interaction with multiple Communities that they might be members of. Activities taking place within each Community are summarized for each individual user. These workspaces allow users to analyze and manipulate CMDB data—without affecting critical production configurations. Built-in governance allows users to publish proposed CMDB changes while ensuring that the actual CMDB updates are performed only by authorized personnel. Continuous versioning allows users to back out changes. Members are also able to bookmark “favorites” of related CIs as well as build shared reports contained within a Community workspace for usage by other Community members or visitors.

By distributing CIs across Communities and providing computer implemented mechanisms by which members of the Communities can search, view, and operate on CI and CI attributes in a continually iterative model, IT organizations can rely on their CMDBs to stay accurate and current and realize the value of their CMDB implementations.

An aspect of the invention is a computer implemented method of managing the quality of CI data contained in a CMDB where the CMDB itself exists in either a single database, a distributed loosely coupled database, or a federated series of databases, and where a computer implemented application allows individual users within Communities to perform the functions of creating CIs, editing CIs, deleting CIs, marking CIs as inaccurate, marking CIs as accurate, marking CIs as incomplete, associating varying levels of importance to CIs, and viewing history of changes of CIs.

Another aspect of the invention is a computer implemented method of managing the quality of CI attribute data associated with every CI within a CMDB, where a computer implemented application allows individual users within Communities to perform the functions of creating CI attributes, editing CI attributes, deleting CI attributes, marking CI attributes as inaccurate, marking CI attributes as accurate, marking CI attributes as incomplete, associating varying levels of importance to CI attributes, and viewing history of changes of CI attributes.

It is also an aspect of the invention to have computer implemented social networks of individual users with assigned roles granting permissions for any combination of creation, modification, deletion, update, comment, tagging, and marking of CI and CI attributes. A variation on this aspect of the invention is to have communities comprised of groups of these individuals with community permissions covering any combination of creation, modification, deletion, update, tagging, and marking of CI and CI attributes. A further variation of this aspect of the invention is to have a set of one or more CIs associated with each community.

Yet another aspect of the invention is a computer implemented method where individuals can create CIs or CI attributes within a community should suitable permissions, of the kind described above, allow them to do so. The invention also contemplates a computer implemented method where individuals can delete CIs or CI attributes within a community should the permissions allow them to do so. In a further aspect of the invention individuals can modify CI or CI attributes within a community.

Another aspect of the invention is a computer implemented method where individuals with suitable permissions can tag CI or CI attributes within a community. Tags can be assigned an arbitrary value, including but not limited to: “Inaccurate”, “Needs to be updated”, “To be decommissioned”. In a further aspect of the invention searches can be conducted of all CIs or CI attributes which have been tagged with arbitrary values. The invention also provides for a computer implemented method where members of a community with suitable permissions can perform operations such as report generation, browsing, and sorting on all CIs or CI attributes.

Yet another aspect of the invention is a computer implemented method where individuals having appropriate permissions create, delete, modify or tag CIs or CI attributes, and apply them to a subset of CIs or CI attributes generated by report generation, browsing, or sorting of CIs or CI attributes. It is also an aspect of the invention to track full details and history of the foregoing tasks for any and all CIs and CI attributes in the CMDB.

A further aspect of the invention is a computer implemented method for generating graphical and text reports containing some or all of the information described in the foregoing paragraph. It is also an aspect of the invention to provide a computer implemented method for individuals to view information in these text reports for any CIs or CI attributes should they have the appropriate permissions. Yet another aspect of the invention is a computer implemented method to associate a community based perspective with each of the above aspects of the invention.

The implementation of the invention described herein provides a method and system for maintaining data quality of CIs in a configuration management database of an enterprise, the computer being used to organize—or enable the organization of—CIs into communities. The computer also associates individuals with one or more of the communities, each individual associated with a community having particular expertise within the enterprise with respect to one or more CIs in the community. The capabilities implemented on the computer enable an individual in the community to view the CIs allocated to the community, and also to add or delete or otherwise update one of the CIs or its attributes, where the configuration item touches upon the particular expertise of the individual. Then the update is displayed to other individuals associated with communities containing the configuration item, typically by adding the update to an event feed that is made available to these other individuals.

Each of the communities of CIs may be logically related by function, role, class, or geographic location, depending upon the underlying CMDB implementation. In a typical implementation, an individual associates with a community of CIs by subscribing to the community.

In another aspect, the invention may be implemented by having the computer enable a mapping of permissions for individuals- to perform operations on CIs. These operations typically include read, create, modify, delete, update, tag, mark, and comment. A further aspect of the invention is that the computer displays relationships between communities, CIs, and individuals within the enterprise. The computer may also enable the individual to tag a configuration item for review by another individual associated with the community, and to ensure that such review is itself reviewed by other individuals associated with the community prior to committing the update into the configuration management database.

Another aspect of the invention is using a computer to provide workspaces to facilitate the work being done by those associated with particular communities. These workspaces may include community workspace enabling individuals associated with the community to monitor updates being made to CIs. They may also include individual workspace enabling an individual to monitor and update CIs in each community with which the individual is associated. In a further aspect, the computer implementation provided by the invention allows the individual to create reports and associate these reports with a community, and enables the individual to create bookmarks for favorite CIs or reports and to share the bookmarks within the community.

Declared interest groups in the form of Communities applying the foregoing aspects of the invention to a CMDB will result in higher data quality by harnessing distribution of the tasks of evaluating and updating CI and CI attributes contained within the CMDB. As CIs and CI attributes are created, modified, deleted, or flagged, these changes are broadcast as a stream to all subscribed Community members encouraging them to review and make changes to the information as needed.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is schematic diagram showing a sample process by which a CI and its attributes are constructed.

FIG. 2 is a schematic diagram showing associations between individuals and communities, and between CIs and communities, which form a foundation for operation of social network capabilities to improve CI data quality.

FIG. 3 is an exemplar flow chart showing how application of social networking and community methods in accordance with the invention improve data quality.

FIG. 4 shows a sample CI with correct and accurate information contained in a CMDB.

### DETAILED DESCRIPTION OF A PREFERRED EMBODIMENT OF THE INVENTION

A Configuration Management Database (CMDB) is comprised of large numbers, potentially in the millions, of Configuration Items (CIs). A CI is an entity in the CMDB that contains attributes describing a physical or logical object. Usage and utility of the CMDB is dependent on the accuracy of the CI attributes, and maintaining a high degree of accuracy is a constant challenge when deploying a CMDB in a large enterprise. Social networks within a large enterprise, made up of interconnected individuals and groups of individuals (Communities), can be associated with groups of one or more CIs. This associative behavior can be used to drive improvements to data quality within the CMDB as a whole. The social networking and communities approach serve the purpose of distributing the tasks of ensuring accuracy and currency of data contained in the CMDB to people within the organization.

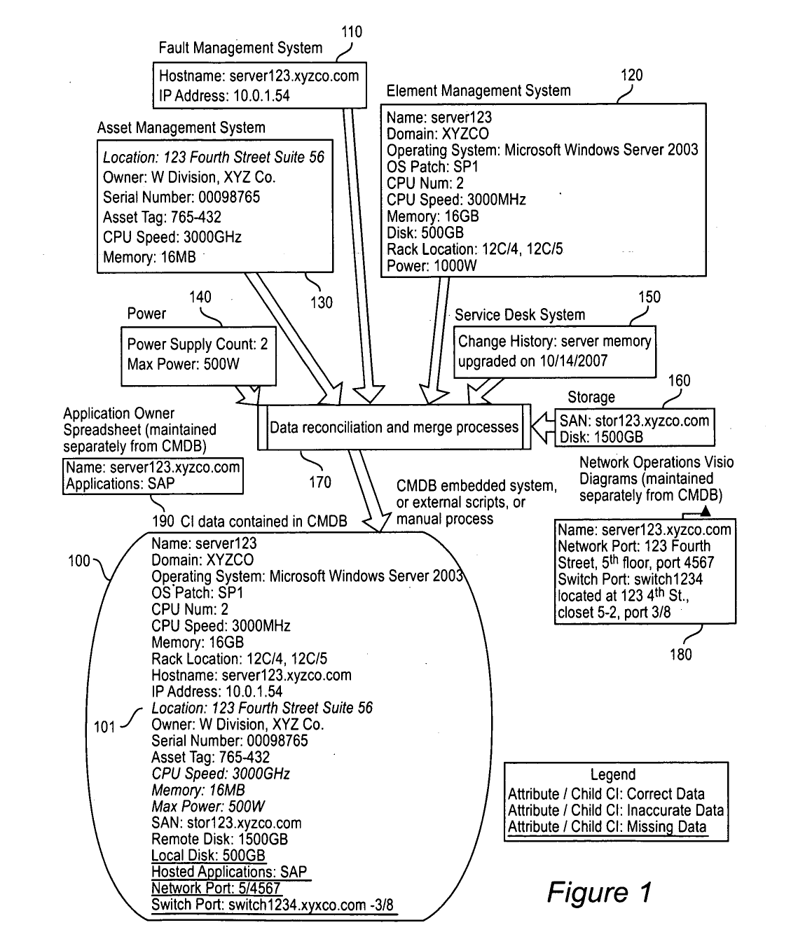

FIG. 1 presents a sample scenario within an IT organization where a CMDB has been constructed to hold detailed information about their CIs by merging disparate sources resulting in inaccurate and missing data. This represents the state of current CMDB data in most IT environments. In the example shown in FIG. 1, the CI is a Server, named “server123”. The organization requires that key information about the server be maintained as attributes associated with the CI. The information contained within the CI attributes is held in a variety of data sources including a Fault Management System 110, Element Management System 120, Service Desk System 150, Asset Management System 130, Storage 160, Power 140, Application Owner 190, and Network Operations Diagrams 180.

IT organizations are generally required to extract information from the original sources wherever possible, provide a reconciliation process 170 (either manual or automated), and combine it all together into a CMDB where the CI 100 and CI attributes can be stored. In every CMDB implementation, there is information that resides in sources that are not easily tapped. In some cases, these can be spreadsheets stored in non-standard formats and locations (such as the Application Owner Spreadsheet 190 in this example) or even held in “tribal memory” by members of the IT staff responsible for maintaining the system.

The end result of this manual and automated merge process is a CI 100 which has critical flaws in it. In this example, information from the Network Operations Visio Diagrams 180 is entirely missing. Also, the CI attribute called Location 101 is incorrect. The root causes of these issues in data quality are varied. In some cases, the source information itself is incorrect (e.g. location 101 information sourced from the Asset Management System 130). In other cases, data is stored in non-standard locations (e.g. Network Operations Visio Diagram 180). Information can also be held within a specialized group from where it cannot be easily obtained, such as the Application Owner Spreadsheet 190.

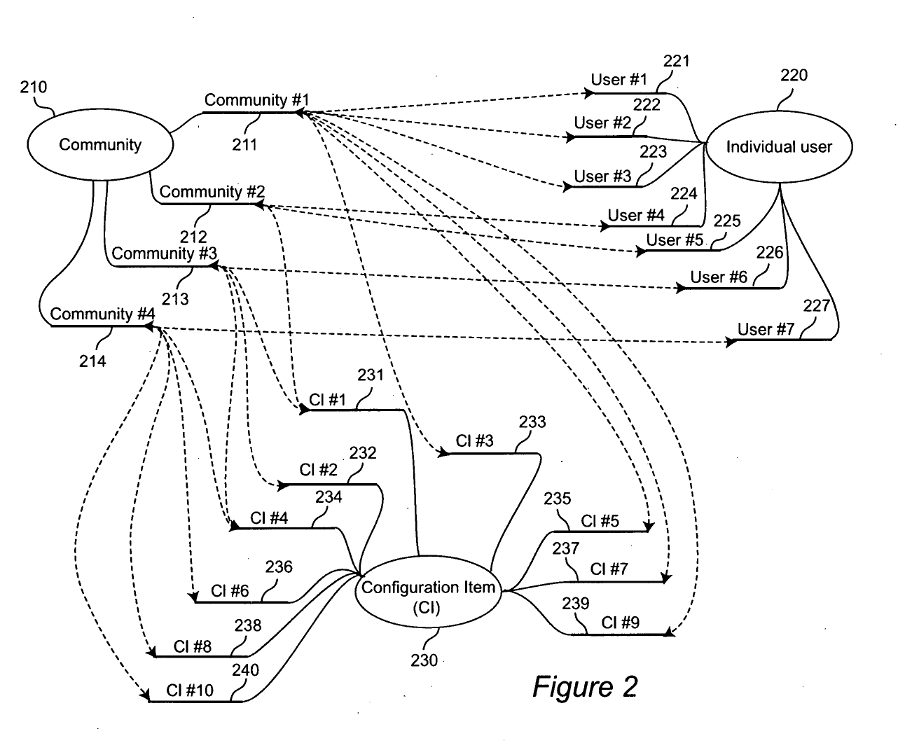

FIG. 2 describes the infrastructure provided by the computer implemented methods described in this invention. It illustrates the relationships between CIs 230, Communities 210 and Users 220. A CI 230 can belong to one or more communities 210 with a subset of its attributes being maintained by each community. Configuration items #3 233, #5 235, #7 237 and #9 239 belong to Community #1 211. Configuration item #1 231 belongs to both Community #2 212 and Community #3 213. Configuration item #2 232 belongs to Community #3 213, and Configuration item #4 234 belongs to both Community #3 213 and Community #4 214. Configuration items #6 236, #8 238 and #10 240 belong to Community #4 214.

Individual users 220 can be associated with one or more Communities and therefore with one or more CIs. For example, as shown in FIG. 2, three users (User #1 221, User #2 222 and User #3 223) are associated with Community #1 211. Users #4 224 and #5 225 are associated with Community #2 212. Users #6 226 and #7 227 are associated with Community #3 213 and Community #4 214, respectively.

These associations form the core of the social network upon which this invention builds. The end goal is to take the traditionally monolithic CMDB and separate it into Communities 210 where related CIs 230 and IT staff with specialized knowledge pertaining to these CIs can be brought together for the purpose of validating and updating CIs and CI attributes. Each member of a community that has an association with, or interest in, a CI can contribute to the data quality of the CI, either by directly manipulating the data, or by annotating and flagging quality issues with the data. What the invention does is make sure that other members are advised of these contributions, via a chronological feed that is filtered to suit the CI association and interest of the other members.

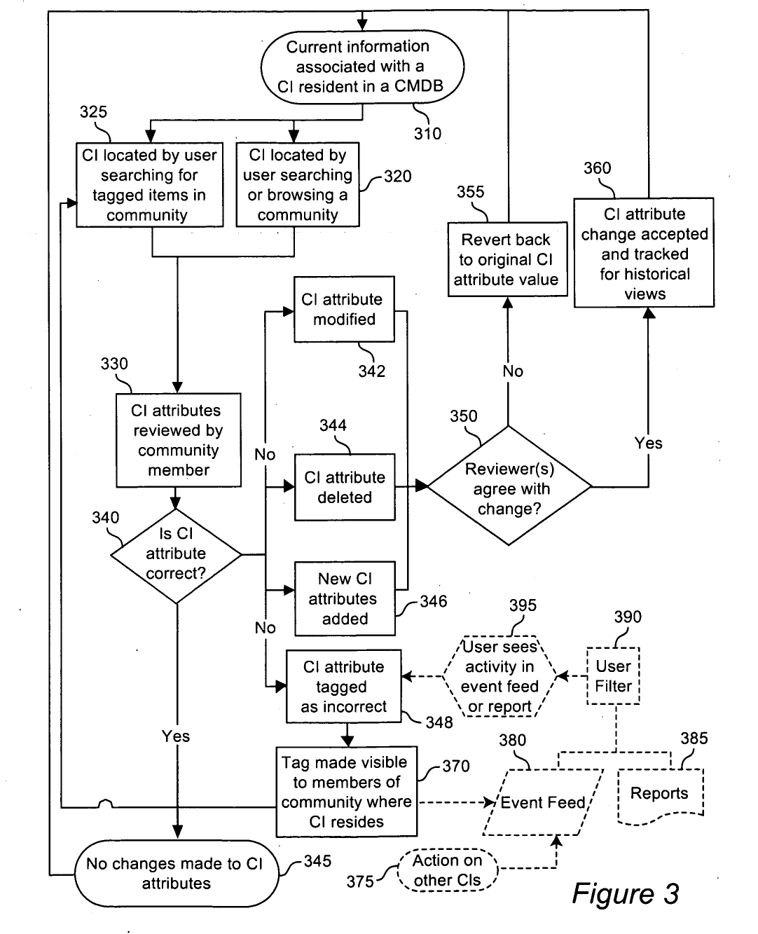

FIG. 3 is a flowchart which illustrates an example of the process by which the core aspects of this invention are applied in an iterative fashion to achieve accuracy and currency for CI and CI attribute data in the CMDB. Those skilled in the art will appreciate that the invention can be implemented using other processes varying in structure and detail yet enabling the same collaborative review and maintenance of the accuracy of CI data in a CMDB.

In the example described in FIG. 1, the CI 100 named “server123” is missing information and some of the information stored in the attributes is incorrect. Item 310 in the flowchart represents this state in the CMDB. For the purposes of this example, it will be assumed that the server123 CI resides in the Communities titled “Servers”, and “123 4^{th} Street”, each of which is associated with its own set of users in the manner described for FIG. 2. In Step 320, CI server123 is located by a user searching for servers in the 123 4th Street Community. The user reviews the attributes of the CI in step 330, and asks at step 340 whether a CI attribute is correct. If the CI attribute is correct, then no change is made to CI attributes, as indicated in step 345. But in this case the user notes that there is no Suite 56 in the building as described in the Location attribute. The user then updates at step 342 the attribute to read “123 Fourth Street Suite 567.” Note that the other options available at this point in the process are to delete the attribute at step 344 or to add new CI attributes at step 346.

Users in the Community who have the reviewer role exercise their role at step 350, and are notified by viewing the overall event feed for the community which indicates the flagging activity by the original user, or are directly routed the flagging activity into a computer-generated inbox. These community reviewers either accept the change as being correct at step 360, thereby removing an error in the CMDB, or cause the modified attribute to revert back to its original value at step 355.

The above workflow is a simple application of the principles defined in this invention. In the case where the correct location information is unknown to the user who notes the error, the CI attribute can be tagged as “Incorrect” at step 348 but not actually corrected. The tag is made visible at step 370 to members of the community where the CI resides. A second user who is a member of the “123 4^{th} Street” Community would locate the server123 CI when searching for “Incorrect” tagged CIs in step 325. Reviewing the CI attributes in step 330, the second user would be able to update the data if the correct information is known or could leave it up to another user to do so instead. If the update is correct, then following steps 342 and 360 would result in CMDB accuracy increasing. However, if the second user updates the CI attribute incorrectly, the reviewer would reject it at step 350 and at step 355 it would revert back to the original CI attribute value and the tag would remain for correction in a later iteration.

As individual users are increasingly involved in the CMDB environment through the user of Community and Individual workspaces, this process is repeatedly applied to CIs and CI attributes in each Community. Each iteration incrementally corrects information that was wrong because of dated information or a failure in the reconciliation process as well as the addition of information that was missing entirely. Community involvement is encouraged by the use of computer displays which show to other community members activities which are of interest to those other community members, thus providing an effect to draw participants together.

This practical effect may be further illustrated with reference to FIG. 3. Actions such as CI tagging 348 are published 370 to other members of the community (or communities) where the CI resides. As indicated above, this visibility may be accomplished by adding the action to a time-ordered event display such as event feed 380. Other members of the community (or other communities) who have an interest in this CI may have their attention drawn 385 to it by use of filters and reports which highlight from the event feed 380 those CIs of interest. The significance of the event feed 380, and the filters and reports which highlight CIs of interest to particular community members, is that the event feed 380 will include actions on other CIs, which may have relationships which draw user attention 385 in ways that are not anticipated by the orderly flow chart exemplar shown in the remainder of FIG. 3, as suggested by the distinguishing dashed lines associated with items 375, 380 and 385. Indeed, the tagging action 348 may be generated in the first instance by user attention drawn in just this way.

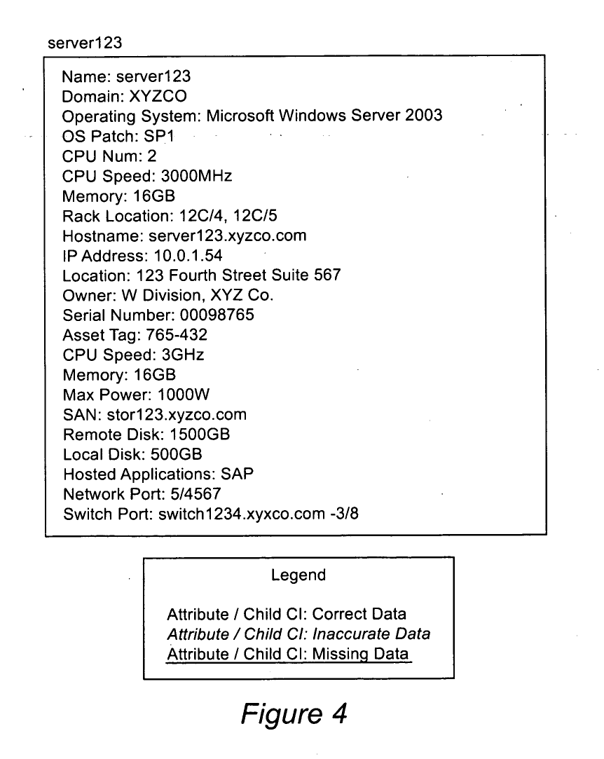

FIG. 4 illustrates the final state of the server123 CI and its attributes highlighting the end result of the repeated application of the process in FIG. 3 to the original data in FIG. 1 enabled by the social network described in FIG. 2.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A computer implemented method for maintaining data quality of configuration items in a configuration management database of an enterprise, the computer performing the steps of:
enabling configuration items to be organized into communities;
enabling association of individuals with one or more of said communities, each individual associated with a community having particular expertise within the enterprise with respect to one or more configuration items in the community;
enabling an individual in the community to view the configuration items in the community;
enabling the individual to add or delete or otherwise update one of the configuration items or its attributes, where the configuration item touches upon the particular expertise of the individual; and
displaying said configuration item update to other individuals associated with communities containing the configuration item.

2. A computer implemented method as in claim 1, wherein each of the communities consist of configuration items logically related by one or more of the group comprising function, role, class, or geographic location.

3. A computer implemented method as in claim 1, wherein an individual associates with a community of configuration items by subscribing to the community.

4. A computer implemented method as in claim 1, the computer performing the further step of enabling a mapping of permissions for individuals to perform operations on configuration items.

5. A computer implemented method as in claim 4, wherein the operations include read, create, modify, delete, update, tag, mark, and comment.

6. A computer implemented method as in claim 1, the computer performing the further step of displaying relationships between communities, configuration items, and individuals within the enterprise.

7. A computer implemented method as in claim 1, the computer performing the further step of enabling the individual to tag a configuration item for review by another individual associated with the community.

8. A computer implemented method as in claim 1, the computer performing the further step of enabling review of the updates made by the individual of a configuration item, the review being conducted by other individuals associated with the community and being conducted prior to committing the update into the configuration management database.

9. A computer implemented method as in claim 1, the computer performing the further step of providing a community workspace enabling individuals associated with the community to monitor updates being made to configuration items.

10. A computer implemented method as in claim 1, the computer performing the further step of providing the individual with an individual workspace enabling the individual to monitor and update configuration items in each community with which the individual is associated.

11. A computer implemented method as in claim 1, the computer performing the further step of enabling the individual to create reports and associate these reports with a community.

12. A computer implemented method as in claim 1, the computer performing the further step of enabling the individual to create bookmarks for favorite configuration items or reports and to share the bookmarks within the community.

13. A system for maintaining data quality of configuration items in a configuration management database of an enterprise, comprising:
means implemented by a computer supporting the configuration management database for organizing configuration items into communities;
means implemented by the computer for associating individuals with one or more of said communities, each individual associated with a community having particular expertise within the enterprise with respect to one or more configuration items in the community;
means implemented by the computer enabling an individual in the community to view the configuration items in the community; and
means implemented by the computer enabling the individual to add or delete or otherwise update one of the configuration items or its attributes, where the configuration item touches upon the particular expertise of the individual; and
means implemented by the computer for displaying said configuration item update to other individuals associated with communities containing the configuration item.

14. A system for maintaining data quality as in claim 13, wherein each of the communities consist of configuration items logically related by one or more specific applications or business processes.

15. A system for maintaining data quality as in claim 13, further comprising means implemented by the computer enabling a mapping of permissions for individuals to perform operations on configuration items.

16. A system for maintaining data quality as in claim 15, wherein the operations include read, create, modify, delete, update, tag, mark, and comment.

17. A computer implemented system for maintaining data quality of configuration items in a configuration management database of an enterprise, the computer system having software modules stored thereon and having a processor operable to execute the software modules, the software modules comprising:
first computer code for organizing configuration items into communities;
second computer code for associating individuals with one or more of said communities, each individual associated with a community having particular expertise within the enterprise with respect to one or more configuration items in the community;
third computer code enabling an individual in the community to view the configuration items in the community;
fourth computer code enabling the individual to add or delete or otherwise update one of the configuration items or its attributes, where the configuration item touches upon the particular expertise of the individual; and
fifth computer code for displaying said configuration item update to other individuals associated with communities containing the configuration item.

18. A computer implemented system for maintaining data quality as in claim 17, further comprising sixth computer code for displaying relationships between communities, configuration items, and individuals within the enterprise.

19. A computer implemented system for maintaining data quality as in claim 17, further comprising:
seventh-computer code enabling the individual to tag a configuration item for review by another individual associated with the community; and
eighth computer code enabling review of the updates made by the individual of a configuration item, the review being conducted by other individuals associated with the community and being conducted prior to committing the update into the configuration management database.

20. A computer implemented system for maintaining data quality as in claim 17, further comprising eighth computer code providing the individual with an individual workspace enabling the individual to monitor and update configuration items in each community with which the individual is associated.
